(19) United States
(12) Patent Application Publication
(10) Pub. No.: US 2019/0178486 A1
(43) Pub. Date: Jun. 13, 2019

(54) MODULE FOR LED LIGHTING FIXTURE

(71) Applicant: Wei Chen, Zibo (CN)

(72) Inventor: Wei Chen, Zibo (CN)

(21) Appl. No.: 15/840,331

(22) Filed: Dec. 13, 2017

(51) Int. Cl. F21V 29/74; F21V 17/18; F21V 17/12; F21V 31/00

(52) U.S. Cl. CPC F21V 29/74; F21V 17/18; F21Y 2115/10; F21V 31/005; F21V 17/12

(57) ABSTRACT

An LED lamp module may include a housing having a bottom plate and a cover which are buckled together, an LED light-emitting component disposed in an inner space of the housing, a thermal conductive plate attached to an inner surface of the bottom plate, and an LED light-emitting plate attached to the thermal conductive plate. In one embodiment, the thermal conductive fins which are perpendicularly bent backward are arranged at a periphery of the thermal conductive plate, and fin sleeves sleeving the thermal conductive are arranged at a periphery of the bottom plate. The LED lamp module utilizing plastic cladding aluminium technology has advantageous because it has great heat dissipation performance, less complicated manufacturing process and lower manufacturing costs.

### FIELD OF THE INVENTION

The present invention relates to a LED illumination module, and more particular to a module for an LED lighting fixture utilizing plastic cladding aluminium technology.

### BACKGROUND OF THE INVENTION

An LED light-emitting apparatus used for illumination may generate a great amount of heat. To solve this problem, a fan is usually used to force air circulation to increase the efficiency for heat dissipation. Alternatively, metal heat dissipation sheets can be used to increase heat dissipation areas. However, when using the fan, noises may be generated and more electric energy can be consumed, so metal heat dissipation sheets are more preferable for increasing the heat dissipation efficiency. However, it is complicated to integrate the metal heat dissipation sheets into the LED lamps because the inner surface thereof is configured to contact the light-emitting board of the LED lamp directly while a plurality of heat dissipation fins have to be formed on the outer surface thereof. With such configuration, the production and manufacturing difficulty has been significantly increased, which leads to an increase of the production and manufacturing costs. Moreover, the danger of electric shock also exists.

Therefore, there remains a need for a new and improved high power LED lighting fixture to have great heat dissipation performance, less complicated manufacturing process, and lower manufacturing costs.

### SUMMARY OF THE INVENTION

It is an object of the present invention to provide an LED lamp module to have great heat dissipation performance, less complicated manufacturing process, and lower manufacturing costs.

It is another object of the present invention to provide an LED lamp module to incorporate plastic cladding aluminium technology to enhance the performance of the LED lamp module.

In one aspect, an LED lamp module may include a housing having a bottom plate and a cover which are buckled together, an LED light-emitting component is arranged in an inner space of the housing, and a thermal conductive plate attached to an inner surface of the bottom plate. In one embodiment, the housing is rectangular, and the LED light-emitting plate is attached to the thermal conductive plate, so the bottom plate, the thermal conductive plate and the LED light-emitting plate are integrated to form a laminated structure with three layers, and the thermal conductive plate is arranged in the middle between the bottom plate and the LED light-emitting plate. With this configuration, a heat conduction distance becomes short to increase the efficiency of heat dissipation. Also, the three-layered laminated structure is integrated together by screws to strengthen the structure and enhance waterproof effect.

A plurality of thermal conductive fins which are perpendicularly bent backward are arranged at a periphery of the thermal conductive plate, and fin sleeves sleeving each of the thermal conductive fins are arranged at a periphery of the bottom plate. In one embodiment, the thermal conductive plate and the thermal conductive fins can be integratedly formed by a stamped aluminium plate molding technique, while the bottom plate and the fin sleeves can be integratedly formed by an engineering plastic injection molding technique.

For the convenience of processing and manufacturing, the thermal conductive fins can be spacedly arranged. For example, a plurality of thermal conductive fins can be spacedly arranged on long edges of the rectangular thermal conductive plate, and a plurality of fin sleeves can be correspondingly arranged on long edges of the bottom plate corresponding to each thermal conductive fins. In one embodiment, only one thermal conductive fin and only one fin sleeve can be arranged on the short edges of the thermal conductive plate and the bottom plate. In another embodiment, the thermal conductive fin and the fin sleeve can be disposed at each of the two ends of the short edges. It is noted that the rectangular housing can be easily used to combine with other finished products in various types.

To improve the heat dissipation efficiency of the bottom plate, a plurality of protruding ribs are formed at an outer surface of the backside of the bottom plate to increase the areas for heat dissipation. Each fin sleeve has an inner wall portion and an outer wall portion arranged in a parallel manner. Furthermore, the back ends and the two sides of each inner wall portion and each outer wall portion are connected together to form a closed structure, and an opening is formed at a front end of the inner wall portion and an outer wall portion to receive the thermal conductive fin. An engaging button is formed at an outer surface of each outer wall plate to secure the cover.

A power box is disposed at the outer surface of the bottom plate, and a window which communicates with an inner space of the power box is formed on the bottom plate. The power box is used for housing a power assembly of the LED light-emitting plate.

### BRIEF DESCRIPTION OF THE DRAWINGS

FIG. 1 is a perspective view of the module of the LED lighting fixture in the present invention.

FIG. 2 is backside view the module of the LED lighting fixture in the present invention.

FIG. 3 is a section view of A-A in FIG. 2.

FIG. 4 is a section view of B-B in FIG. 2.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

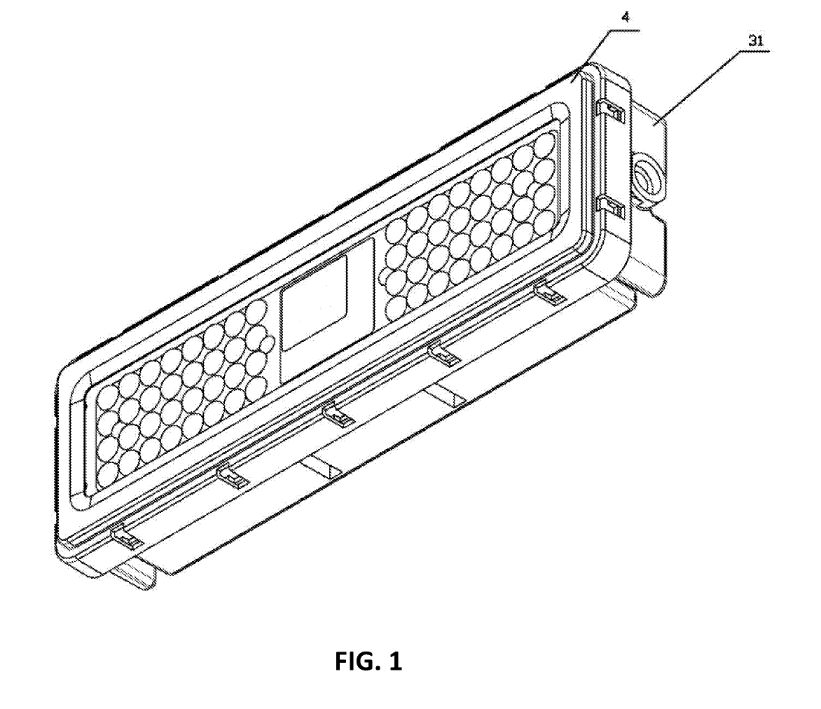

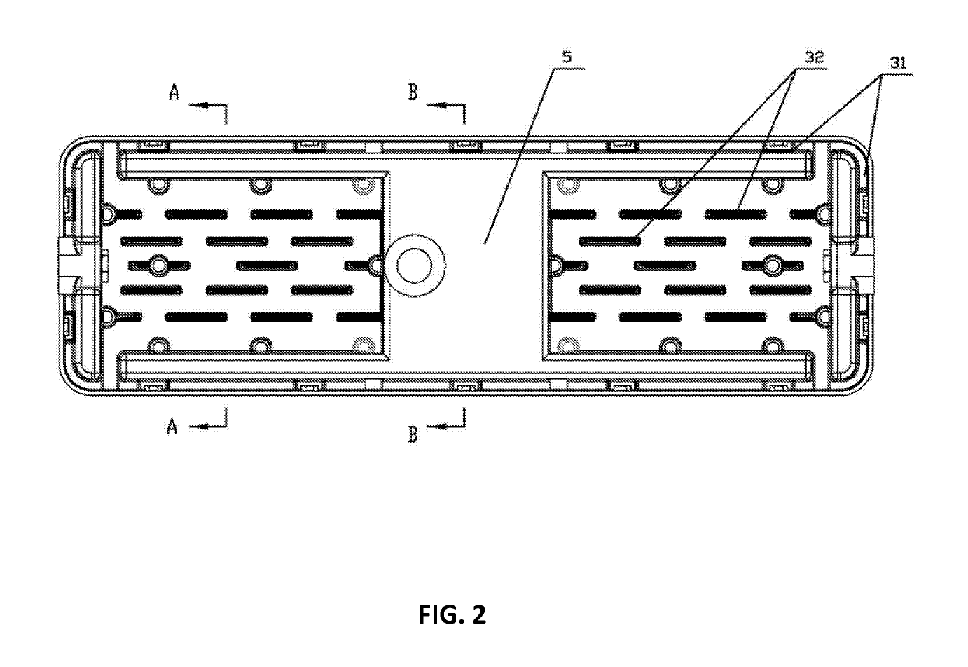

In one aspect, as shown in FIGS. 1 and 2, an LED lamp module may include a housing having a bottom plate 3 and a cover 4 which are buckled together, an LED light-emitting component arranged in an inner space of the housing, and a thermal conductive plate 2 attached to an inner surface of the bottom plate 3. In one embodiment, the housing is rectangular, and an LED light-emitting plate 1 is attached to the thermal conductive plate 2, so the bottom plate 3, the thermal conductive plate 2 and the LED light-emitting plate 1 are integrated to form a laminated structure with three layers, and the thermal conductive plate 2 is arranged in the middle between the bottom plate 3 and the LED light-emitting plate 1. With such configuration, a heat conduction distance becomes short to increase the efficiency of heat dissipation. Also, the three-layered laminated structure is integrated together by screws to strengthen the structure and enhance waterproof effect.

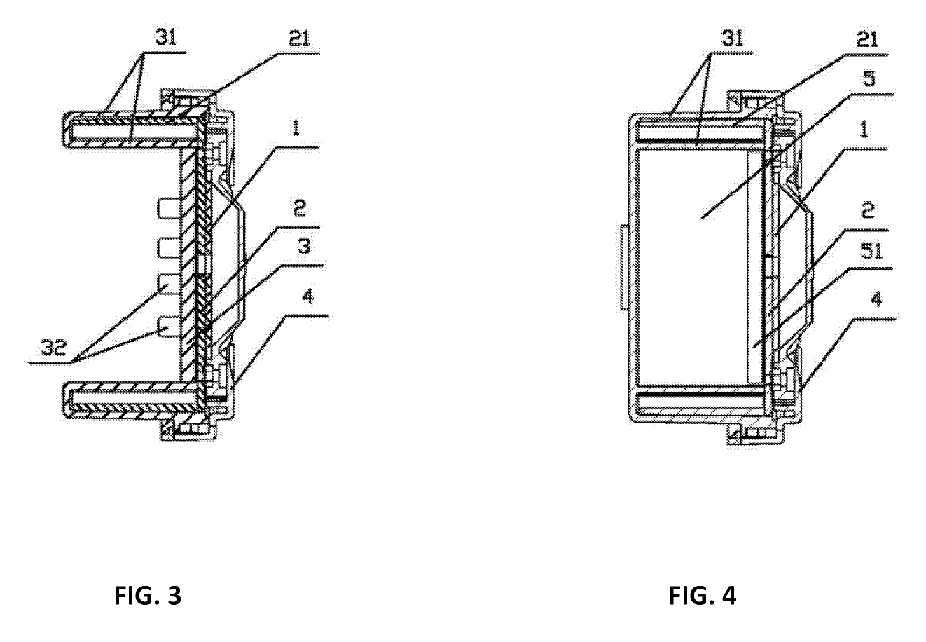

As shown in FIGS. 3 and 4, a plurality of thermal conductive fins 21 which are perpendicularly bent backward are arranged at a periphery of the thermal conductive plate 2, and fin sleeves 31 sleeving each of the thermal conductive fins 21 are arranged at a periphery of the bottom plate 3. In one embodiment, the thermal conductive plate 2 and the thermal conductive fins 21 can be integratedly formed by a stamped aluminium plate molding technique, while the bottom plate 3 and the fin sleeves 31 can be integratedly formed by an engineering plastic injection molding technique.

For the convenience of processing and manufacturing, the thermal conductive fins 21 can be spacedly arranged. For example, as shown in the rectangular structure in FIG. 1, a plurality of thermal conductive fins 21 can be spacedly arranged on long edges of the rectangular thermal conductive plate 2, and a plurality of fin sleeves 31 can be correspondingly arranged on long edges of the bottom plate 3 corresponding to each thermal conductive fins 21. In one embodiment, only one thermal conductive fin and only one fin sleeve can be arranged on the short edges of the thermal conductive plate 2 and the bottom plate 3. In another embodiment, the thermal conductive fin and the fin sleeve can be disposed at each of the two ends of the short edges. It is noted that the rectangular housing can be easily used to combine with other finished products in various types.

To improve the heat dissipation efficiency of the bottom plate 3, a plurality of protruding ribs 32 are formed at an outer surface of the backside of the bottom plate 3 to increase the areas for heat dissipation. Each fin sleeve 31 has an inner wall portion and an outer wall portion arranged in a parallel manner. Furthermore, the back ends and the two sides of each inner wall portion and each outer wall portion are connected together to form a closed structure, and an opening is formed at a front end of the inner wall portion and an outer wall portion to receive the thermal conductive fin. An engaging button is formed at an outer surface of each outer wall plate to secure the cover 4.

A power box 5 is disposed at the outer surface of the bottom plate 3, and a window 51 which communicates with an inner space of the power box 5 is formed on the bottom plate 3. The power box 5 is used for housing a power assembly of the LED light-emitting plate 1

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. An LED lighting fixture comprising a housing having a bottom plate and a cover which are buckled together; an LED light-emitting component arranged in an inner space of the housing; a thermal conductive plate attached to an inner surface of the bottom plate, and an LED light-emitting plate attached to the thermal conductive plate, so the bottom plate, the thermal conductive plate and the LED light-emitting plate are integrated to form a laminated structure with three layers, and the thermal conductive plate is arranged in the middle between the bottom plate and the LED light-emitting plate to shorten a heat conduction distance to increase heat dissipation efficiency.

2. The LED lighting fixture of claim 1, wherein the housing is rectangular.

3. The LED lighting fixture of claim 2, wherein a plurality of thermal conductive fins which are perpendicularly bent backward are arranged at a periphery of the thermal conductive plate, and fin sleeves sleeving each of the thermal conductive fins are arranged at a periphery of the bottom plate.

4. The LED lighting fixture of claim 3, wherein the thermal conductive plate and the thermal conductive fins are integratedly formed by a stamped aluminium plate molding technique.

5. The LED lighting fixture of claim 3, wherein the bottom plate and the fin sleeves are integratedly formed by an engineering plastic injection molding technique.

6. The LED lighting fixture of claim 3, wherein the thermal conductive fins are spacedly arranged on long sides of the rectangular thermal conductive plate, and the fin sleeves are correspondingly arranged on long sides of the rectangular bottom plate corresponding to each thermal conductive fins.

7. The LED lighting fixture of claim 1, wherein a plurality of protruding ribs are formed at an outer surface of a backside of the bottom plate to increase areas for heat dissipation.
